(19) United States
(12) Patent Application Publication
(10) Pub. No.: US 2025/0242862 A1
(43) Pub. Date: Jul. 31, 2025

(54) Utility Vehicle

(71) Applicant: Rheinmetall MAN Military Vehicles Österreich GesmbH, Vienna (AT)

(72) Inventors: Emanuel Scherr, Wien (AT); Manfred Schuldhaus Schuldhaus, Wien (AT); Thomas Buchmasser, Wien (AT); Manuel Winkler, Wien (AT)

(21) Appl. No.: 18/854,226

(22) PCT Filed: Feb. 15, 2023
(86) PCT No.: PCT/EP2023/053740

§ 371 Date: Oct. 4, 2024

(30) Foreign Application Priority Data
Apr. 7, 2022 (DE) 10 2022 108 469.8

(51) Int. Cl. B62D 7/10; B62D 7/14

(52) U.S. Cl. CPC B62D 7/10; B62D 7/144

(57) ABSTRACT

A utility vehicle includes a chassis frame, a front axle coupled to the chassis frame and having steerable wheels, and a rear axle coupled to the chassis frame. A steering system is used to deflect the wheels of the front axle and includes a steering gear arranged between the front axle and the rear axle. The steering system includes a redirection lever arranged in front of the front axle and is coupled to a first coupling rod that is coupled to the steering gear. A second coupling rod is coupled to the redirection lever and to a wheel carrier of the front axle. On actuation of the steering gear, the first coupling rod and the second coupling rod are configured to deflect the steerable wheels to turn the utility vehicle in the desired direction.

### CROSS-REFERENCE TO RELATED APPLICATION(S)

This application is filed pursuant to 35 U.S.C. § 371 claiming priority benefit to PCT/EP2023/053740 filed Feb. 15, 2023, which claims priority benefit to German Patent Application 102022108469.8 filed Apr. 7, 2022, the contents of both applications are incorporated herein by reference in the entirety for all purposes.

### TECHNICAL FIELD

The present invention relates to a utility vehicle.

### BACKGROUND

Utility vehicles can comprise a chassis with a chassis frame and axles coupled to the chassis frame, which are at least partially steerable. To steer such a steerable axle, a steering gear can be provided, which is coupled to a wheel carrier of the steerable axle by means of coupling rods. Furthermore, reversing gears can also be provided.

EP 2 938 530 B1 describes a utility vehicle of this type. The utility vehicle comprises a driver's cab which is arranged at least partially in front of a steerable front axle. A steering gear for steering the steerable front axle is located under the driver's cab and thus in front of the steerable front axle.

### SUMMARY

Against this background, one task of the present invention is to provide an improved utility vehicle.

Accordingly, a utility vehicle is proposed. The utility vehicle comprises a chassis frame which extends along a length direction of the utility vehicle, a front axle which is coupled to the chassis frame, and which carries steerable wheels, a rear axle which is coupled to the chassis frame, and a steering system for deflecting the wheels of the front axle, wherein the steering system comprises a steering gear which is arranged between the front axle and the rear axle when viewed along the length direction. The steering system comprises a redirection lever, a first coupling rod, with the aid of which the steering gear is coupled to the redirection lever, and a second coupling rod, with the aid of which the redirection lever is coupled to a wheel carrier of the front axle, and wherein the redirection lever is arranged in front of the front axle when viewed along the length direction.

Because the steering gear is mounted between the front axle and the rear axle, it is possible to place a driver's housing, a driver's cab or a driver's workstation on a plateau of the utility vehicle above the steering gear and thus between the front axle and the rear axle. The utility vehicle can thus be provided with an engine hood or hood that protrudes above the front axle. This makes it possible, for example, to give the utility vehicle a more powerful engine and use an internal combustion engine with a larger installation space. This increases the possible range of use of the utility vehicle.

Preferably, the chassis frame, the front axle, the rear axle and the steering system are part of a chassis of the utility vehicle. In addition to the length direction along which the chassis frame extends, a transverse direction, along which the front axle and the rear axle extend, and a height direction are assigned to the utility vehicle, the chassis frame and/or the chassis. The length direction, the transverse direction and the height direction are positioned perpendicular to each other and preferably form a coordinate system of the utility vehicle, the chassis frame and/or the chassis.

For example, the utility vehicle comprises a front axle, a first rear axle and a second rear axle. This means that two rear axles can be provided. At least the front axle is steered or steerable. The utility vehicle can be a three-axle vehicle. However, the utility vehicle can also be a two-axle vehicle, a four-axle vehicle or a five-axle vehicle. The utility vehicle can thus comprise several front axles and several rear axles. Alternatively, the utility vehicle can also comprise exactly one front axle. In addition to the front axle, the rear axle can also be steered. The rear axle also comprises wheels. Single or twin tires can be provided on the front axle and/or on the rear axle.

The utility vehicle is preferably a military utility vehicle and can therefore also be referred to as such. In particular, this means that the terms “utility vehicle” and “military utility vehicle” can be used interchangeably. The utility vehicle is preferably a land vehicle, in particular a truck. The utility vehicle can be a tractor unit. However, this is not mandatory. The utility vehicle can also comprise a body supported by the chassis or the chassis frame. The utility vehicle can also be used for military purposes, in which case it is referred to as a military utility vehicle. In particular, the utility vehicle is an all-terrain truck. The utility vehicle may be a protected or armored utility vehicle or may be designated as such. The utility vehicle is a multi-axle vehicle, in particular a two-axle vehicle, a three-axle vehicle or a four-axle vehicle. The utility vehicle preferably comprises an all-wheel drive. The utility vehicle may therefore also be referred to as an all-wheel drive utility vehicle.

Preferably, the front axle and the rear axle are each coupled to the chassis frame by means of leaf spring packages. Each leaf spring package may comprise a plurality of leaf springs or leaf spring elements that are combined to form the respective leaf spring package. In particular, the utility vehicle is a so-called “hood”. In the present case, a “hood” is to be understood in particular as a utility vehicle which comprises an engine hood or hood which, viewed along the length direction, extends out of a driver's housing or a driver's cab of the utility vehicle supported by the chassis or the chassis frame. The hood can be arranged at least in sections above the front axle. Preferably, the driver's cab is positioned at least in sections behind the front axle when viewed along the length direction. The steering system can be retrofitted to the chassis or chassis frame. Alternatively, instead of the driver's housing or the driver's cab, a driver's workstation can be designed on a platform that can be used for transfer purposes.

The steering system comprises a redirection lever, a first coupling rod, with the aid of which the steering gear is coupled to the redirection lever, and a second coupling rod, with the aid of which the redirection lever is coupled to a wheel carrier of the front axle.

Preferably, the steering system comprises the redirection lever and a steering lever that differs from the redirection lever. The steering lever is preferably provided on the steering gear. The redirection lever is coupled to the respective wheel carrier of the front axle with the aid of the second coupling rod. The first coupling rod is deflected with the help of the steering lever. The first coupling rod in turn deflects the redirection lever, which deflects the second coupling rod and thus the respective wheel carrier. The front axle preferably comprises an axle body, which is coupled to the chassis frame with the aid of the leaf spring packages mentioned above. A first wheel carrier and a second wheel carrier are provided at the ends of the axle body. The wheel carriers are pivotably mounted on the axle body. Each wheel carrier carries a wheel that can be rotated relative to the respective wheel carrier. The first coupling rod can also be referred to as the first push rod. The second coupling rod can also be referred to as the second push rod. In particular, the first coupling rod and the second coupling rod each extend along the length direction. By using the steering lever, the redirection lever and the coupling rods, it is advantageous to dispense with the use of redirection gears or angular gears. The steering system is therefore preferably free of reversing gears or without reversing gears or free of angular gears or without angular gears.

According to another embodiment, the front axle comprises a first wheel carrier and a second wheel carrier, wherein the redirection lever is coupled to the first wheel carrier with the aid of the second coupling rod, and wherein the first wheel carrier and the second wheel carrier are coupled to one another with the aid of a track rod.

The wheel carriers and the track rod can be part of the steering system. The track rod can also be referred to as the first track rod. The track rod extends in particular along the transverse direction. The first wheel carrier preferably comprises a first track lever. Accordingly, the second wheel carrier comprises a second track lever. The first track lever and the second track lever are connected to each other by means of the track rod. This ensures that when the first wheel carrier is deflected, the second wheel carrier is deflected in the same way. At least one of the wheel carriers, preferably the first wheel carrier, comprises a steering lever which is coupled to the second coupling rod. When the second coupling rod is deflected, the first wheel carrier is thus deflected with the aid of its steering lever.

The redirection lever is arranged in front of the front axle when viewed along the length direction.

The steering lever, which is connected to the steering gear, is positioned between the front axle and the rear axle, particularly when viewed along the length direction, and thus behind the front axle.

According to another embodiment, the first coupling rod, viewed along a height direction of the utility vehicle, is guided above the front axle past the latter from the steering gear to the redirection lever.

The first coupling rod thus extends above the front axle when viewed along the height direction. The first coupling rod is arranged so far away from the first front axle along the height direction that the first front axle does not make contact with the first coupling rod when it is compressed.

According to another embodiment, the second coupling rod, viewed along the height direction, is guided below the first coupling rod from the redirection lever towards the wheel carrier.

Preferably, the second coupling rod is arranged between the front axle and the first coupling rod when viewed along the height direction.

According to another embodiment, the redirection lever is rotatably mounted on the chassis frame with the aid of a bearing block and a mounting plate supporting the bearing block.

The bearing block and the mounting plate can be part of the steering system. The redirection lever comprises several receiving sections which are suitable for connecting the respective coupling rod to the redirection lever. The receiving sections can be openings or holes provided on the redirection lever. The respective coupling rod can comprise ball heads, which are connected to the receiving sections of the redirection lever using bolts, for example. One of the receiving sections is particularly suitable for receiving the bearing block, at least in sections.

According to another embodiment, the mounting plate comprises a receiving section in which the bearing block is received at least in sections.

The receiving section can be an aperture or a bore. The bearing block preferably comprises a cylindrical first bearing section and a cylindrical second bearing section. In particular, the second bearing section is accommodated in the receiving section of the mounting plate. The first bearing section can be accommodated in one of the receiving sections of the redirection lever.

According to another embodiment, the chassis frame comprises a first longitudinal beam running along the length direction, a second longitudinal beam running along the length direction, and a plurality of cross beams running along a transverse direction of the utility vehicle, which cross beams connect the longitudinal beams to one another, wherein the steering gear is mounted on one of the longitudinal beams.

The longitudinal beams and the cross beams can be riveted, bolted and/or welded together. Together, the longitudinal beams and the cross beams form the ladder-shaped chassis frame. The chassis frame can therefore also be referred to as a ladder frame. Preferably, the steering gear is mounted on the first longitudinal beam. The steering gear can be bolted to the first longitudinal beam.

According to another embodiment, the steering gear is mounted on the one of the longitudinal beams with the aid of a mounting console, wherein the mounting console holds the steering gear at a distance from the one of the longitudinal beams when viewed along the transverse direction.

The mounting console can be part of the steering system. Preferably, the steering gear is mounted on the first longitudinal beam with the aid of the mounting console. Accordingly, the mounting console also holds the steering gear at a distance from the first longitudinal beam when viewed along the transverse direction. The mounting console can be bolted to the first longitudinal beam, whereby the steering gear is bolted to the mounting console. With the aid of the mounting console, the steering gear can be mounted at a distance from the first longitudinal beam when viewed along the transverse direction. This makes it possible, for example, to place the steering lever between the steering gear and the first longitudinal beam. As a result, the first coupling rod, which leads from the steering lever to the redirection lever, can be supplied as close as possible to the longitudinal beam.

According to another embodiment, the utility vehicle further comprises a first front axle which is coupled to the chassis frame and carries steerable wheels, and a second front axle which is coupled to the chassis frame and carries steerable wheels, wherein the steering gear is arranged between the first front axle and the second front axle when viewed along the length direction.

In addition to the first front axle and the second front axle, the utility vehicle can comprise a first rear axle and a second rear axle. Preferably, only the first front axle and the second front axle are steered. However, the first rear axle and the second rear axle are preferably not steered. Alternatively, the rear axles or one of the rear axles can also be steered. Accordingly, the steering gear is positioned along the length direction both between the first front axle and the second front axle and between the first front axle and the first rear axle. In particular, the second front axle is arranged between the first front axle and the first rear axle.

According to another embodiment, the steering system comprises a third coupling rod, with the aid of which the steering gear is coupled to a wheel carrier of the second front axle.

The third coupling rod is part of the steering system. The third coupling rod can also be referred to as the third push rod. In particular, the third coupling rod is connected to the steering lever mounted on the steering gear. Via the steering lever and the third coupling rod, the steering gear is directly coupled to one of the wheel carriers of the second front axle. The second front axle comprises an axle body and wheel carriers provided at the ends of the axle body. A first wheel carrier and a second wheel carrier are provided. Each wheel carrier carries a wheel. The third coupling rod preferably couples the steering gear to the first wheel carrier of the second front axle.

According to another embodiment, the second front axle comprises a first wheel carrier and a second wheel carrier, wherein the steering gear is coupled to the first wheel carrier with the aid of the third coupling rod, and wherein the first wheel carrier and the second wheel carrier are coupled to one another with the aid of a track rod.

The track rod is part of the steering system. The track rod can also be referred to as the second track rod. The track rod runs along the transverse direction. With the help of the track rod, it is possible to transfer a deflection of the first wheel carrier directly to the second wheel carrier. This eliminates the need for a separate linkage of the second wheel carrier. In particular, the track rod is coupled to a steering lever of the first wheel carrier.

According to another embodiment, the utility vehicle further comprises a driver's cab and a hood extending from the front side of the driver's cab when viewed along the length direction. As previously mentioned, the utility vehicle is a so-called hood or can be referred to as a hood. Accordingly, the utility vehicle may also be referred to as a military hood. Preferably, the utility vehicle comprises an internal combustion engine which is arranged below the hood. The internal combustion engine may be arranged in front of the front axle when viewed along the length direction. Alternatively, the internal combustion engine can also be positioned partially or centrally above the front axle when viewed along the length direction. The internal combustion engine can be accessible via the hood.

According to another embodiment, the driver's cab is arranged behind or at least partially behind the front axle when viewed along the length direction.

Accordingly, the driver's cab can be arranged at least partially above the front axle. In particular, the driver's cab is arranged above the steering gear. A steering wheel is provided in the driver's cab, which is coupled to the steering gear by means of a steering column. The steering wheel and the steering column are in particular part of the steering system. The steering column extends in particular along the height direction.

In the present case, “one” is not necessarily to be understood as being limited to exactly one element. Rather, several elements, such as two, three or more, can also be provided. Any other counting word used here is also not to be understood as meaning that there is a restriction to exactly the specified number of elements. Rather, numerical deviations upwards and downwards are possible, unless otherwise stated.

Other possible implementations of the utility vehicle also include combinations of features or embodiments described above or below with regard to the embodiment examples that are not explicitly mentioned. The person skilled in the art will also add individual aspects as improvements or additions to the respective basic form of the utility vehicle.

### BRIEF DESCRIPTION OF THE DRAWINGS

Further advantageous embodiments and aspects of the utility vehicle are the subject of the subclaims, and the embodiments of the utility vehicle described below. In the following, the utility vehicle is explained in more detail with reference to the enclosed figures.

FIG. 1 shows a schematic side view of an embodiment of a utility vehicle;

FIG. 2 shows a schematic perspective view of an embodiment of a chassis for the utility vehicle according to FIG. 1;

FIG. 3 shows a schematic side view of the chassis according to FIG. 2;

FIG. 4 shows a schematic top view of the chassis according to FIG. 2;

FIG. 5 shows a schematic perspective view of an embodiment of a steering gear for the chassis according to FIG. 2;

FIG. 6 shows a schematic perspective view of an embodiment of a mounting console for the chassis according to FIG. 2;

FIG. 7 shows a schematic perspective view of an embodiment of a steering lever for the chassis according to FIG. 2;

FIG. 8 shows a schematic perspective view of an embodiment of a redirection lever for the chassis according to FIG. 2;

FIG. 9 shows a schematic perspective view of an embodiment of a bearing block for the chassis according to FIG. 2;

FIG. 10 shows a schematic perspective view of an embodiment of a mounting plate for the chassis according to FIG. 2;

FIG. 11 shows a schematic perspective view of a further embodiment of a chassis for the utility vehicle according to FIG. 1;

FIG. 12 shows a schematic side view of the chassis according to FIG. 11; and

FIG. 13 shows a schematic top view of the chassis as shown in FIG. 11.

### DETAILED DESCRIPTION

In the figures, identical or functionally identical elements have been given the same reference symbols, unless otherwise stated.

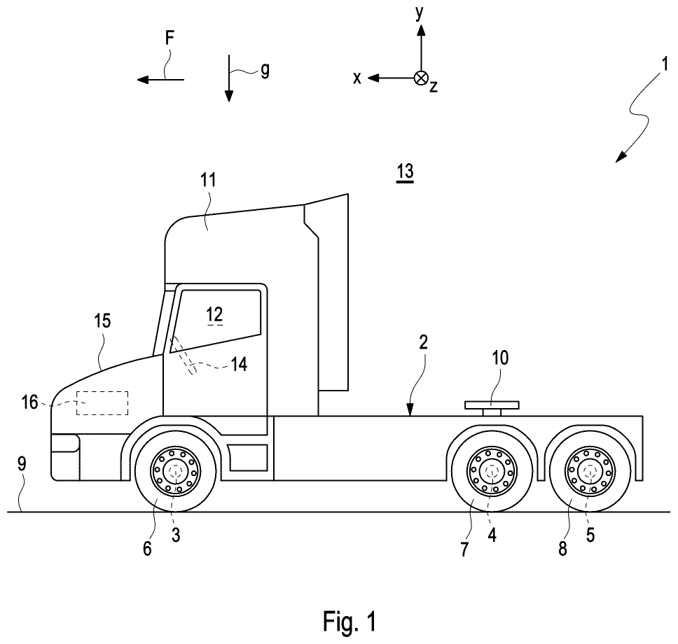

FIG. 1 shows a schematic side view of an embodiment of a utility vehicle 1. The utility vehicle 1 is preferably a military utility vehicle 1 and can therefore also be referred to as such. In particular, this means that the terms “utility vehicle” and “military utility vehicle” can be used interchangeably. The utility vehicle 1 may also be referred to as a military utility vehicle. The utility vehicle 1 is a heavy-duty utility vehicle 1 or may be referred to as such. The utility vehicle 1 is a land vehicle, in particular a wheeled vehicle. The utility vehicle 1 may be a truck. The utility vehicle 1 may be a tractor unit, as shown in FIG. 1. However, the utility vehicle 1 can also be a truck with a body. The utility vehicle 1 can be a protected vehicle.

A coordinate system with an x-direction or length direction x, a y-direction or height direction y and a z-direction or transverse direction z is assigned to the utility vehicle 1. The directions x, y, z are oriented perpendicular to each other. The height direction y is oriented parallel to a direction of gravity g. The direction of gravity g is oriented from top to bottom in the orientation shown in FIG. 1. The height direction y is oriented in the opposite direction to the direction of gravity g. The length direction x is oriented from right to left in the orientation of FIG. 1. The length direction x can also be referred to as the first spatial direction. The height direction y can also be referred to as the second spatial direction. The transverse direction z can also be referred to as the third spatial direction.

The utility vehicle 1 comprises a chassis 2 with a front wheel axle or front axle 3, a first rear wheel axle or first rear axle 4 and a second rear wheel axle or second rear axle 5. Preferably, both the front axle 3 and the rear axles 4, 5 are driven, so that the utility vehicle 1 comprises all-wheel drive. At least the front axle 3 is steerable. In addition, the rear axles 4, 5 or at least one of the rear axles 4, 5 can also be steerable. The utility vehicle 1 can comprise more than one front axle 3. For example, two front axles 3 are provided (not shown). In this case, both front axles 3 are steerable.

Wheels 6 are assigned to the front axle 3. Single tires or twin tires can be provided. In the first case, two wheels 6 are assigned to the front axle 3. In the second case, four wheels 6 are assigned to the front axle 3. Wheels 7, 8 are assigned to the rear axles 4, 5. Here too, either single tires or twin tires can be provided. As previously mentioned, all wheels 6 to 8 can be driven. Alternatively, only some of the wheels 6 to 8 can be driven. With the aid of the wheels 6 to 8, the utility vehicle 1 can move along and against a driving direction F on a subsoil 9. The driving direction F can be oriented along the length direction x. The subsoil 9 can be a road or any terrain. A saddle plate 10 is provided on the chassis 2. The saddle plate 10 can be used to couple a semi-trailer or saddle semi-trailer to the utility vehicle 1. The chassis 2 carries a driver's housing or a driver's cab 11. The driver's cab 11 can be protected or armored. The driver's cab 11 is preferably protected against shelling, booby traps, improvised explosive devices (IED), mines or the like.

The driver's cab 11 encloses an interior 12 in which a vehicle driver and/or a crew can stay. The interior 12 is accessible from a surroundings 13 of the utility vehicle 1 through doors, hatches or the like. A steering wheel 14 for steering the front axle 3 is provided within the interior 12. Viewed along the length direction x, the driver's cab 11 is positioned behind or at least in sections behind the front axle 3.

The utility vehicle 1 comprises an engine hood or hood 15, which extends out of the driver's cab 11 to the left in the orientation shown in FIG. 1. Viewed along the length direction x, the hood 15 is positioned in front of or at least in sections in front of the front axle 3. The hood 15 can cover an internal combustion engine 16 of the utility vehicle 1. The internal combustion engine 16 can be a diesel engine or a gasoline engine. However, the utility vehicle 1 may also be electrically powered or comprise a hybrid drive. In the latter case, the utility vehicle 1 also comprises an electric motor in addition to the internal combustion engine 16.

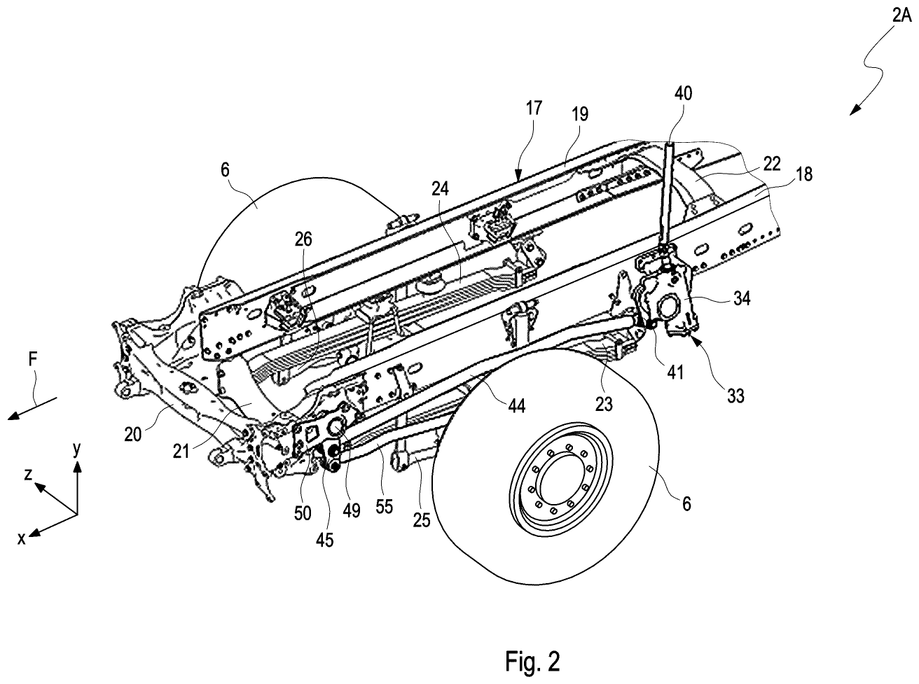

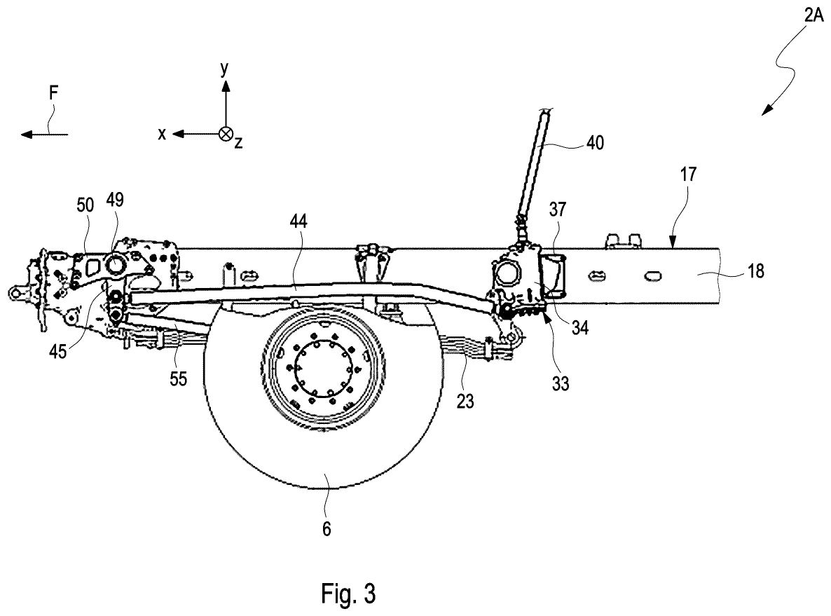

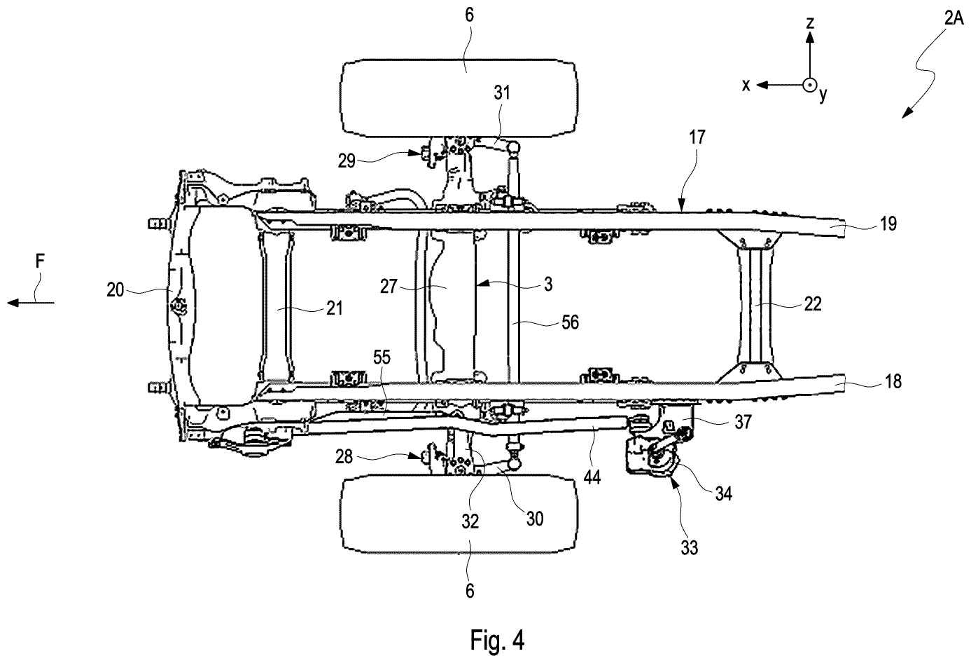

FIG. 2 shows a schematic perspective view of an embodiment of a chassis 2A as mentioned above. FIG. 3 shows a schematic side view of the chassis 2A. FIG. 4 shows a schematic top view of the chassis 2A. In the following, reference is made simultaneously to FIGS. 2 to 4.

The chassis 2A comprises a chassis frame 17 extending along the length direction x. The chassis frame 17 comprises a first longitudinal beam 18 and a second longitudinal beam 19 arranged at a distance from the first longitudinal beam 18 along the transverse direction z. The longitudinal beams 18, 19 extend along the length direction x. The longitudinal beams 18, 19 may, for example, comprise a C-shaped cross-section. The longitudinal beams 18, 19 can be steel profiles. However, other materials can also be used.

The longitudinal beams 18, 19 are connected to each other by means of several cross beams 20 to 22 extending in the transverse direction z. The longitudinal beams 18, 19 and the cross beams 20 to 22 can be bolted, riveted and/or welded together. The longitudinal beams 18, 19 and the cross beams 20 to 22 together form the ladder-shaped chassis frame 17. The chassis frame 17 can therefore also be referred to as a ladder frame or is a ladder frame.

The front axle 3 is a rigid axle. However, this is not absolutely necessary. Instead of the front axle 3 in the form of a rigid axle, an independent wheel suspension can also be provided. The front axle 3, on which two wheels 6 are rotatably mounted, is coupled to the chassis frame 17 by means of leaf spring packages 23, 24. A first leaf spring package 23 is assigned to the first longitudinal beam 18. A second leaf spring package 24 is assigned to the second longitudinal beam 19. Instead of the leaf spring packages 23, 24, any other suspension can also be provided. The front axle 3 is supported on the longitudinal beams 18, 19 with the aid of support struts 25, 26. A first support strut 25 is assigned to the first longitudinal beam 18. A second support strut 26 is assigned to the second longitudinal beam 19.

The front axle 3 comprises an axle body 27, which is coupled to the chassis frame 17 by means of the leaf spring packages 23, 24 and the support struts 25, 26. A first wheel carrier 28 and a second wheel carrier 29 of the front axle 3 are provided at the ends of the axle body 27. A wheel 6 is assigned to each wheel carrier 28, 29. The wheels 6 are rotatably mounted on the respective wheel carrier 28, 29. The wheel carriers 28, 29 are rotatable relative to the axle body 27 in order to deflect the wheels 6. The first wheel carrier 28 comprises a first track lever 30. The second wheel carrier 29 comprises a second track lever 31. In addition to the first track lever 30, the first wheel carrier 28 comprises a steering lever 32.

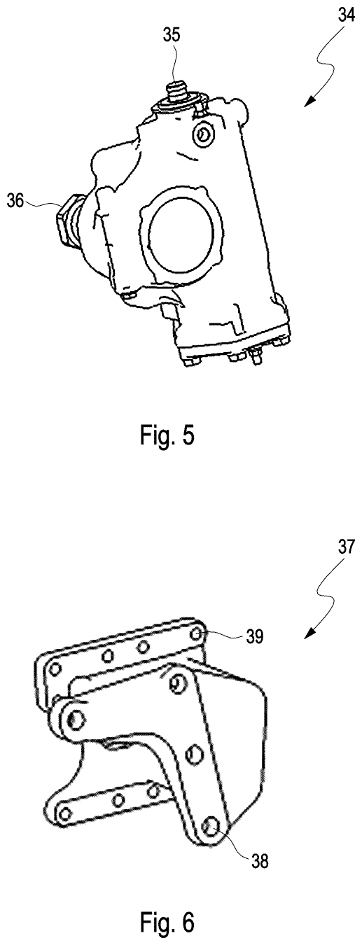

The utility vehicle 1 or the chassis 2A comprises a steering system 33. The steering system 33 can be used to deflect the wheels 6. The wheel carriers 28, 29 can be part of the steering system 33. The steering system 33 comprises a steering gear 34 (FIG. 5). The steering gear 34 is a hydraulic gear. The steering gear 34 comprises a first connection section 35 and a second connection section 36. The steering gear 34 is positioned behind the front axle 3 when viewed along the length direction x. For example, the steering gear 34 is attached to the first longitudinal beam 18.

The steering gear 34 can be mounted on the chassis frame 17 or on the first longitudinal beam 18 with the aid of a mounting console 37 (FIG. 6). For example, the steering gear 34 is bolted to the mounting console 37, which in turn is bolted to the first longitudinal beam 18. For this purpose, the mounting console 37 can comprise first mounting bores 38, only one of which is provided with a reference sign, and second mounting bores 39, also only one of which is provided with a reference sign. The steering gear 34 is screwed to the mounting console 37 with the aid of the first mounting bores 38. The mounting console 37 is bolted to the first longitudinal beam 18 with the aid of the second mounting bores 39.

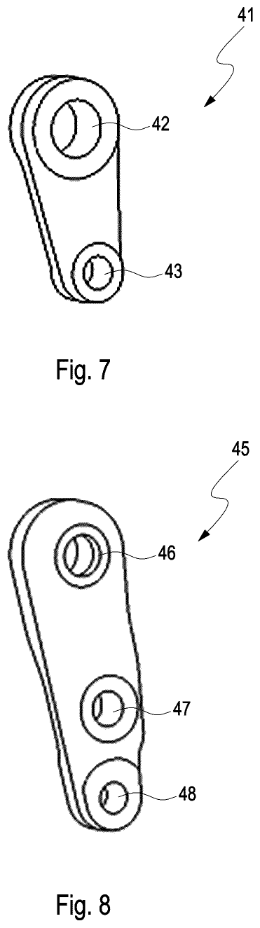

A steering column 40 is connected to the first connection section 35 of the steering gear 34. The steering column 40 protrudes into the interior 12. The steering wheel 14 is mounted at the end of the steering column 40. The steering wheel 14 is part of the steering system 33. A steering lever 41 (FIG. 7) is mounted on the second connection section 36 of the steering gear 34.

The steering lever 41 comprises a first receiving section 42, in which the second connection section 36 of the steering gear 34 is received. The first receiving section 42 can be an aperture or a bore. The second connection section 36 is firmly connected to the steering lever 41. In addition to the first receiving section 42, the steering lever 41 comprises a second receiving section 43. The receiving sections 42, 43 are positioned at a distance from one another.

A first coupling rod 44 is mounted on the second receiving section 43 of the steering lever 41. The first coupling rod 44 runs along the first longitudinal beam 18 past the front axle 3. The first coupling rod 44 runs above the front axle 3 in the orientation shown in FIGS. 2 to 4. The first coupling rod 44 supplies a redirection lever 45 (FIG. 8). The redirection lever 45 comprises a first receiving section 46, with the aid of which the redirection lever 45 is rotatably mounted on the chassis frame 17, in particular on the first longitudinal beam 18, a second receiving section 47 and a third receiving section 48. The receiving sections 46 to 48 can be formed as apertures or bores.

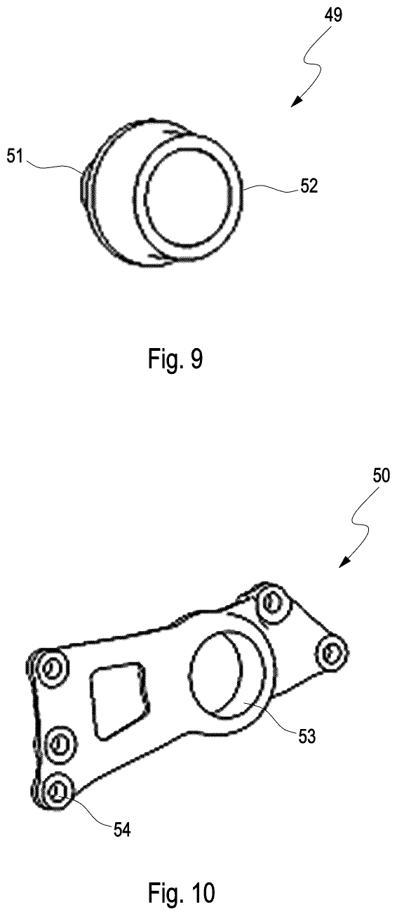

The redirection lever 45 is rotatably mounted on the first longitudinal beam 18 by means of a bearing block 49 (FIG. 9) and a mounting plate 50 (FIG. 10). The bearing block 49 comprises a stepped cylindrical geometry with a cylindrical first bearing section 51, which is rotatably received in the first receiving section 46 of the redirection lever 45, and a cylindrical second bearing section 52.

The mounting plate 50 comprises a receiving section 53 which is suitable for receiving the second bearing section 52 of the bearing block 49. The bearing block 49 is arranged between the first longitudinal beam 18 and the mounting plate 50. The mounting plate 50 further comprises a plurality of mounting bores 54, of which only one is provided with a reference sign in FIG. 10. With the aid of the mounting bores 54, the mounting plate 50 can be screwed to the first longitudinal beam 18.

The first coupling rod 44 is pivotably connected to the redirection lever 45 by means of the second receiving section 47 of the redirection lever 45. A bolt or the like, which is received in the second receiving section 47, can be provided for the connection between the first coupling rod 44 and the second receiving section 47. A second coupling rod 55 guides from the redirection lever 45 to the steering lever 32 of the first wheel carrier 28. The second coupling rod 55 is rotatably connected to the redirection lever 45 at the third receiving section 48. Furthermore, the second coupling rod 55 is rotatably connected to the steering lever 32.

The steering system 33 further comprises a track rod 56. The track rod 56 may also be referred to as the first track rod 56. The track rod 56 connects the two track levers 30, 31 of the wheel carriers 28, 29 to each other. For this purpose, the track rod 56 is rotatably connected both to the first track lever 30 and to the second track lever 31. With the aid of the track rod 56, a steering movement of the wheel 6 carried by the first wheel carrier 28 can be transmitted to the wheel 6 carried by the second wheel carrier 29.

The functionality of the steering system 33 is explained below. It is assumed that the utility vehicle 1 is moving in the driving direction F on the subsoil 9. If a vehicle driver now wants to initiate a right turn, for example, he turns the steering wheel 14 clockwise. This rotational movement of the steering wheel 14 is transmitted to the steering gear 34 with the aid of the steering column 40. For this purpose, the first connection section 35 is rotated with the aid of the steering column 40. The steering gear 34 comprises a suitable transmission ratio which translates the rotational movement of the first connection section 35 into a rotational movement of the second connection section 36.

The rotary movement of the second connection section 36 supplies a pivoting movement of the steering lever 41, which causes the first coupling rod 44 to move forward along the driving direction F or along the length direction x and to pivot the redirection lever 45. The pivoting of the redirection lever 45 supplies that the second coupling rod 55 moves backwards against the driving direction F or against the length direction x and deflects the steering lever 32 of the first wheel carrier 28.

By deflecting the steering lever 32, the first wheel carrier 28 is pivoted clockwise, causing the wheel 6 carried by the first wheel carrier 28 to turn to the right. Because the first wheel carrier 28 is coupled to the second wheel carrier 29 by means of the track rod 56, the wheel 6 carried by the second wheel carrier 29 is also steered to the right at the same time. The utility vehicle 1 takes a right-hand bend. In the case of a left-hand bend, the kinematics described above are reversed accordingly.

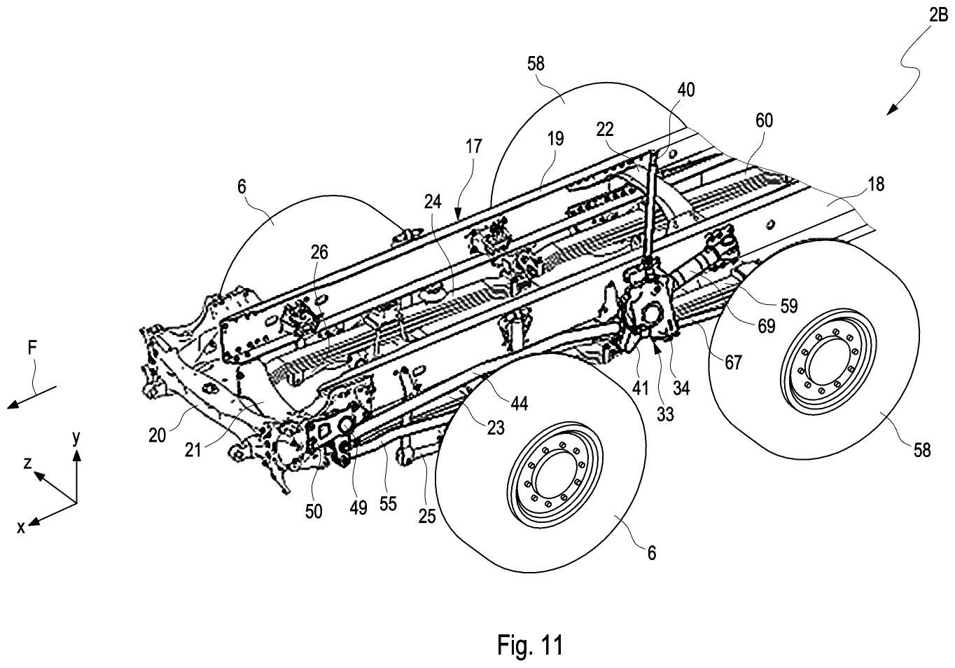

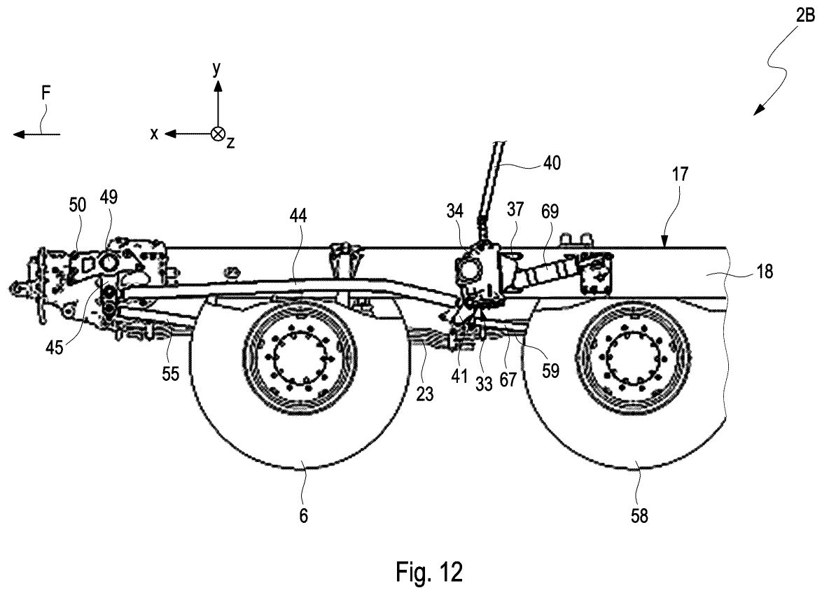

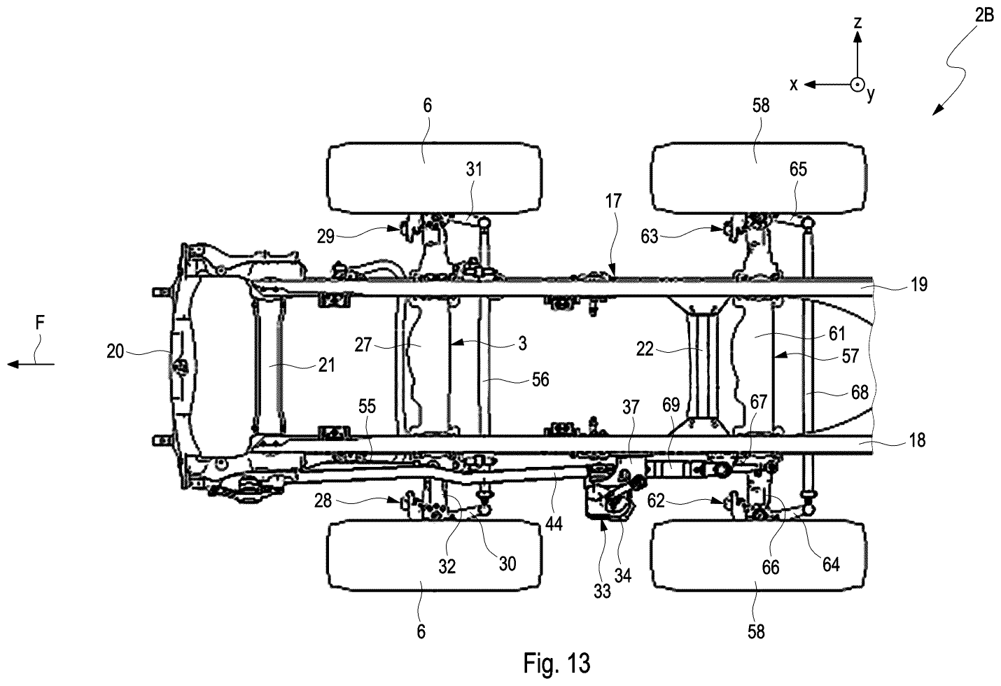

FIG. 11 shows a schematic perspective view of a further embodiment of a chassis 2B as mentioned above. FIG. 12 shows a schematic side view of the chassis 2B. FIG. 13 shows a schematic top view of the chassis 2B. In the following, reference is made simultaneously to FIGS. 11 to 13.

Like the chassis 2A, the chassis 2B comprises a chassis frame 17 with two longitudinal beams 18, 19 running along the length direction x, cross beams 20 to 22 running along the transverse direction z, a front axle 3 and two wheels 6. Furthermore, the chassis 2B comprises a steering system 33 as mentioned above with a steering gear 34, a mounting console 37, a steering column 40, a steering lever 41, a first coupling rod 44, a redirection lever 45, a bearing block 49, a mounting plate 50, a second coupling rod 55 and a track rod 56.

In contrast to the chassis 2A, however, the chassis 2B comprises not only a steerable front axle 3, but also a first steerable front axle 3 and a second steerable front axle 57, to which two wheels 58 are assigned. The second front axle 57 is coupled to the chassis frame 17 by means of leaf spring packages 59, 60. A first leaf spring package 59 is assigned to the first longitudinal beam 18. A second leaf spring package 60 is assigned to the second longitudinal beam 19. The steering gear 34 is positioned between the first front axle 3 and the second front axle 57 when viewed along the length direction x.

The second front axle 57 comprises an axle body 61 with wheel carriers 62, 63 arranged at the ends. A first wheel carrier 62 and a second wheel carrier 63 are provided. The wheel carriers 62, 63 are pivotably mounted on the axle body 61. The first wheel carrier 62 comprises a first track lever 64. The second wheel carrier 63 comprises a second track lever 65. The first wheel carrier 62 further comprises a steering lever 66 for deflecting the first wheel carrier 62.

The steering system 33 also comprises a third coupling rod 67, which couples the steering lever 41 to the steering lever 66. Furthermore, a track rod 68 is provided, which couples the two track levers 64, 65 of the second front axle 57 to one another. The track rod 68 may be referred to as the second track rod 68. Accordingly, the track rod 56 may be referred to as the first track rod 56. A hydraulic cylinder 69 is associated with the steering gear 34 for assisting the steering force.

The steering process is carried out as previously explained with reference to the chassis 2A. The only difference is that the second front axle 57 is deflected together with the first front axle 3. For example, when a right turn is initiated, the third coupling rod 67 is moved forwards along the driving direction F or along the length direction x, whereby the two wheel carriers 62, 63 of the second front axle 57 are pivoted in such a way that the wheels 58 of the second front axle 57, like the two wheels 6 of the first front axle 3, are deflected to the right.

The steering system 33 can advantageously dispense with additional angular gears or reversing gears. This avoids the steering play that occurs with such angular gears or reversing gears. As a result, it is not necessary to regularly replace the angular gears or reversing gears to prevent steering play. This also prevents the steering from becoming imprecise over time. This improves comfort and safety and supports the driver. Feedback from the utility vehicle 1 via the steering wheel 14 is thus authentic and reliable. The steering system 33 can advantageously be mounted as a retrofit solution on the chassis frame 17 or on different chassis frames 17.

Direct articulation of the first wheel carriers 28, 62 by means of the steering gear 34 means that there is no need for articulated steering shafts and reversing gears. As previously mentioned, this leads to freedom from play and thus to high precision of the steering system 33. The geometric design of the steering system 33 ensures good accessibility for maintenance purposes.

Although the present invention has been described with reference to examples of embodiments, it can be modified in many ways.

### LIST OF REFERENCE SIGNS

1 Utility vehicle
2 Chassis
2A Chassis
2B Chassis
3 Front axle
4 Rear axle
5 Rear axle
6 Wheel
7 Wheel
8 Wheel
9 Subsoil
10 Saddle plate
11 Driver's cab
12 Interior
13 Surroundings
14 Steering wheel
15 Hood
16 Internal combustion engine
17 Chassis frame
18 Longitudinal beam
19 Longitudinal beam
20 Cross beam
21 Cross beam
22 Cross beam
23 Leaf spring package
24 Leaf spring package
25 Support strut
26 Support strut
27 Axle body
28 Wheel carrier
29 Wheel carrier
30 Track lever
31 Track lever
32 Steering lever
33 Steering system
34 Steering gear
35 Connection section
36 Connection section
37 Mounting console
38 Mounting bore
39 Mounting bore
40 Steering column
41 Steering lever
42 Receiving section
43 Receiving section
44 Coupling rod
45 Redirection lever
46 Receiving section
47 Receiving section
48 Receiving section
49 Bearing block
50 Mounting plate
51 Bearing section
52 Bearing section
53 Receiving section
54 Mounting bore
55 Coupling rod
56 Track rod
57 Front axle
58 Wheel
59 Leaf spring package
60 Leaf spring package
61 Axle body
62 Wheel carrier
63 Wheel carrier
64 Track lever
65 Track lever
66 Steering lever
67 Coupling rod
68 Track rod
69 Hydraulic cylinder
F Driving direction
g Direction of gravity
x Length direction
y Height direction
z Transverse direction

1. A utility vehicle, comprising
a chassis frame which extends along a length direction (x) of the utility vehicle;
a front axle which is coupled to the chassis frame, and which is configured to support steerable wheels;
a rear axle which is coupled to the chassis frame; and
a steering system configured to deflect the steerable wheels of the front axle,
the steering system further comprising:
a steering gear arranged between the front axle and the rear axle when viewed along the length direction (x);
a redirection lever arranged in front of the front axle when viewed along the length direction (x);
a first coupling rod coupled to the steering gear and the redirection lever; and
a second coupling rod coupled to the redirection lever to a wheel carrier of the front axle.

2. The utility vehicle according to claim 1, wherein the front axle comprises:
a first wheel carrier; and
a second wheel carrier, wherein the redirection lever is coupled to the first wheel carrier by the second coupling rod, and wherein the first wheel carrier and the second wheel carrier are coupled to one another by a first track rod.

3. The utility vehicle according to claim 1, wherein the first coupling rod, viewed along a height direction (y) of the utility vehicle, is positioned above the front axle between the steering gear and the redirection lever.

4. The utility vehicle according to claim 3, wherein the second coupling rod, viewed along the height direction, is positioned below the first coupling rod between the redirection lever and the wheel carrier of the front axle.

5. The utility vehicle according to claim 1, wherein, the redirection lever is rotatably mounted on the chassis frame by a bearing block and a mounting plate supporting the bearing block.

6. The utility vehicle according to claim 5, wherein the mounting plate comprises a receiving section in which the bearing block is received at supported by the mounting plate.

7. The utility vehicle according to claim 1, wherein the chassis frame comprises:
a first longitudinal beam running along the length direction (x);
a second longitudinal beam running along the length direction (x); and
a plurality of cross beams running along a transverse direction (z) of the utility vehicle and configured to connect the first longitudinal beam to the second longitudinal beam, and wherein the steering gear is mounted on one of the first longitudinal beam or the second longitudinal beam.

8. The utility vehicle according to claim 7, wherein the steering gear is mounted on the one of the first longitudinal beam or the second longitudinal beam by a mounting console wherein the mounting console is configured to position the steering gear at a distance from the one of the first longitudinal beam or the second longitudinal when viewed along the transverse direction (z).

9. The utility vehicle according to claim 1, wherein the front axle comprises a first front axle, the utility vehicle further comprising:
a second front axle which is coupled to the chassis frame and which is configured to support steerable wheels, wherein the steering gear is arranged between the first front axle and the second front axle when viewed along the length direction (x).

10. The utility vehicle according to claim 9, wherein the steering system further comprises a third coupling rod coupled to the steering gear and a wheel carrier of the second front axle.

11. The utility vehicle according to claim 10, wherein the wheel carrier of the second front axle comprises:
a first wheel carrier; and
a second wheel carrier, wherein the steering gear is coupled to the first wheel carrier by the third coupling rod, and wherein the first wheel carrier and the second wheel carrier are coupled to one another by a second track rod.

12. The utility vehicle according to claim 1, wherein the utility vehicle further comprises:
a driver's cab; and
a hood extending from a front side of the driver's cab when viewed along the length direction (x).

13. The utility vehicle according to claim 12, wherein the driver's cab is arranged at least partially behind the front axle when viewed along the length direction (x).

14. The utility vehicle according to claim 4 wherein, the redirection lever is rotatably mounted on the chassis frame by a bearing block and a mounting plate supporting the bearing block.

15. The utility vehicle of claim 14, wherein the redirection lever further comprises:
a first receiving section configured to connect to the first coupling rod;
a second receiving section positioned in the height direction (y) below the first receiving section, the second receiving section configured to receive a bearing block, the bearing block is supported by a mounting plate connected to the chassis frame, the bearing block configured to allow rotation of the redirection lever relative to the chassis frame; and
a third receiving section positioned in the height direction (y) below the second receiving section, the third receiving section configured to connect to the second coupling rod, wherein on movement of the first coupling rod along a first direction along the length direction (x), the redirection lever rotates relative to the chassis frame about an axis defined by the second receiving section and the second coupling rod moves in a second direction along the length direction (x) opposite the first direction of movement of the first coupling rod to deflect the steerable wheels of the front axle relative to the chassis frame.

16. The utility vehicle of claim 15, wherein the bearing block is positioned in a transverse direction (z) between the chassis frame and the mounting plate.

17. The utility vehicle of claim 13, wherein the driver's cab is arranged behind the front axle when viewed along the length direction (x).

18. A utility vehicle, comprising
a chassis frame having a first longitudinal beam and a second longitudinal beam extending along a length direction (x), and at least two cross beams connected to the first longitudinal beam and the second longitudinal beam extending along a transverse direction (z);
a front axle coupled to the chassis frame is configured to support steerable wheels, the front axle including a first wheel carrier and a second wheel carrier each configured to support a wheel, the first wheel carrier and the second wheel carrier connected by a first track rod extending in the transverse direct (z);
a rear axle coupled to the chassis frame and positioned rearward from the front axle in the length direction (x); and
a steering system configured to deflect the steerable wheels of the front axle, the steering system further comprising:
a steering gear positioned between the front axle and the rear axle and connected to the first longitudinal beam, the steering gear having a first connection section configured to receive steering input from a steering wheel and a second connection section;
a steering lever connected to the second connection section of the steering gear;
a redirection lever positioned forward of the front axle in the length direction (x), the redirection lever further comprising:
a first receiving section;
a second receiving section positioned below the first receiving section in a height direction (y); and
a third receiving section positioned below the second receiving section in the height direction (y)
a mounting plate positioned outward of the first longitudinal beam in the transverse direction (z) and connected to the first longitudinal beam, wherein the redirection lever is rotatably connected to the mounting plate by a bearing block positioned between the first longitudinal beam and the mounting plate and coupled to the second receiving section of the redirection lever, the bearing block configured to permit rotation of the redirection level about an axis of the second receiving section relative to the first longitudinal beam;
a first coupling rod positioned in the height direction (y) above the front axle and coupled to the steering lever and the first receiving section of the redirection lever; and
a second coupling rod positioned in the height direction (y) below the first coupling rod, the second coupling rod is coupled to the third receiving section of the redirection lever and to the first wheel carrier of the front axle, wherein on steering input to the steering gear at the first connection section, the second connection section of the steering gear is configured to move the steering lever to move the first coupling rod along a first direction along the length direction (x), the redirection lever rotates relative to the first longitudinal beam about the axis of the second receiving section, and the second coupling rod moves in a second direction along the length direction (x) opposite the first direction of movement of the first coupling rod to deflect the steerable wheels of the front axle relative to the chassis frame.

19. The utility vehicle according to claim 18, wherein the front axle comprises a first front axle, the utility vehicle further comprising:
a second front axle coupled to the chassis frame and configured to support steerable wheels, wherein the steering gear is arranged along the length direction between the first front axle and the second front axle; and
the steering system further comprising a third coupling rod coupled to the steering level and a wheel carrier of the second front axle, wherein on steering input to the steering gear at the first connection section, the second connection section of the steering gear is configured to move the steering lever to move the third coupling rod in the first direction along the length direction (x) to deflect the steerable wheels of the second front axle to coordinate movement with the steerable wheels of the first front axle.
